(19) United States
(12) Patent Application Publication
(10) Pub. No.: US 2010/0302584 A1
(43) Pub. Date: Dec. 2, 2010

(54) IMAGE FORMING APPARATUS

(76) Inventor: Yuichi WATANABE, Tokyo (JP)

Correspondence Address: Kubotera & Associates, LLC, 200 Daingerfield Rd, Suite 202, Alexandria, VA, 22314, US

(21) Appl. No.: 12/786,968

(22) Filed: May 25, 2010

(30) Foreign Application Priority Data
May 26, 2009 (JP) 2009-126263

(51) Int. Cl. G06F 3/12; G06F 17/30

(52) U.S. Cl. 358/1.15; 707/769; 707/E17.014

(57) ABSTRACT

An image forming apparatus includes an operation unit for inputting an operation; a job storage unit for storing a job correlating the operation to a sequential operation; a control unit for performing the job; a destination storage unit for storing destination information; and an information searching unit for determining whether the job including an operation of transmission to the destination information is stored in the job storage unit. The control unit is arranged to perform a specific operation when the information searching unit determines that the job including the operation of transmission to the destination information is stored in the job storage unit after the destination information is changed.

### BACKGROUND OF THE INVENTION AND RELATED ART STATEMENT

The present invention relates to an image forming apparatus. More specifically, the present invention relates to an image forming apparatus having a job memory for registering a job.

Patent Reference has disclosed a conventional digital image forming apparatus having multiple functions. The conventional digital image forming apparatus is provided with a touch panel functioning also as a display unit formed of a liquid crystal display (referred to as an LCD), so that the multiple functions can be effectively utilized through a dialog type operation.

In the conventional digital image forming apparatus, a key operation sequence of an image forming condition with a high usage frequency is stored as a job in a job memory using a job memory function, so that the job is displayed on the display unit as an icon. Accordingly, when the job thus registered is performed, it is possible to quickly select the job thus registered. As a result, it is possible to securely perform the job without a cumbersome operation such as opening a confirmation screen.

### Patent Reference Japanese Patent Publication No. 2005-102249

In the conventional image forming apparatus described above, the key operation sequence of the image forming condition with a high usage frequency is stored and registered as the job in the job memory using the job memory function. For example, shortcut push buttons may be registered in an electric mail (referred to as an e-mail) address book, and a key operation sequence of pushing one of the shortcut push buttons may be registered in the conventional image forming apparatus. In this case, if a specific e-mail address is deleted from the e-mail address book before the key operation sequence is registered, when the job registered in the job memory is executed, an e-mail may be sent to a wrong e-mail address.

In view of the problems described above, an object of the present invention is to provide an image forming apparatus capable of solving the problems of the conventional image forming apparatus.

Further objects and advantages of the invention will be apparent from the following description of the invention.

### SUMMARY OF THE INVENTION

In order to attain the objects described above, according to an aspect of the present invention, an image forming apparatus includes an operation unit for inputting an operation; a job storage unit for storing a job correlating the operation input through the operation unit to a sequential operation; a control unit for performing the job stored in the job storage unit; a destination storage unit for storing destination information; and an information searching unit for determining whether the job including an operation of transmission to the destination information is stored in the job storage unit. The control unit is arranged to perform a specific operation when the information searching unit determines that the job including the operation of transmission to the destination information is stored in the job storage unit after the destination information stored in the destination storage unit is changed.

In the aspect of the present invention, the control unit is arranged to perform a specific operation when the information searching unit determines that the job including the operation of transmission to the destination information is stored in the job storage unit after the destination information stored in the destination storage unit is changed. Accordingly, even when the job stored in the job storage unit is executed, it is possible to prevent the destination information from being transmitted to a wrong destination, thereby improving security.

### BRIEF DESCRIPTION OF THE DRAWINGS

FIG. 1 is a block diagram showing a configuration of an image forming apparatus according to a first embodiment of the present invention;

FIG. 2 is a schematic perspective view showing the image forming apparatus according to the first embodiment of the present invention;

FIG. 3 is a schematic view showing an example of a network to which the image forming apparatus is connected according to the first embodiment of the present invention;

FIG. 4 is a schematic view showing an example of contents of a job memory key table of the image forming apparatus according to the first embodiment of the present invention;

FIG. 5 is a schematic view showing an example of contents of an e-mail shortcut dial number table of the image forming apparatus according to the first embodiment of the present invention;

FIG. 6 is a flow chart showing an operation of registering a job in a job memory of the image forming apparatus according to the first embodiment of the present invention;

FIG. 7 is a flow chart showing an operation of executing the job in the job memory of the image forming apparatus according to the first embodiment of the present invention;

FIG. 8 is a flow chart showing an operation of registering and deleting an e-mail shortcut dial number in the job memory of the image forming apparatus according to the first embodiment of the present invention;

FIG. 9 is a flow chart showing an operation of registering and deleting an e-mail shortcut dial number in a job memory of an image forming apparatus according to a second embodiment of the present invention;

FIG. 10 is a block diagram showing a configuration of an image forming apparatus according to a third embodiment of the present invention;

FIG. 11 is a schematic view showing an example of contents of a job memory key table of the image forming apparatus according to the third embodiment of the present invention;

FIG. 12 is a schematic view showing an example of contents of an e-mail shortcut dial number table of the image forming apparatus according to the third embodiment of the present invention; and

FIG. 13 is a flow chart showing an operation of forward-deleting an e-mail shortcut dial number in a job memory of an image forming apparatus according to the third embodiment of the present invention.

### DETAILED DESCRIPTION OF PREFERRED EMBODIMENTS

Hereunder, embodiments of the present invention will be explained with reference to the accompanying drawings. In the following description, the accompanying drawings merely show embodiments of the present invention for describing the present invention. Accordingly, the present invention is not limited to the embodiments shown in the accompanying drawings.

### First Embodiment

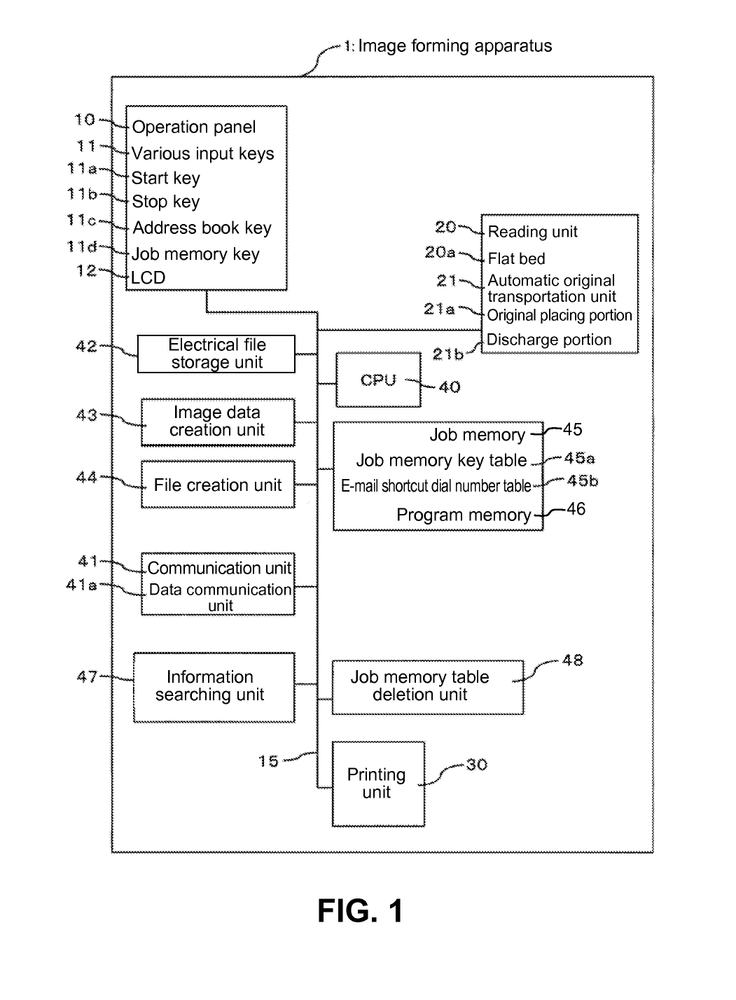

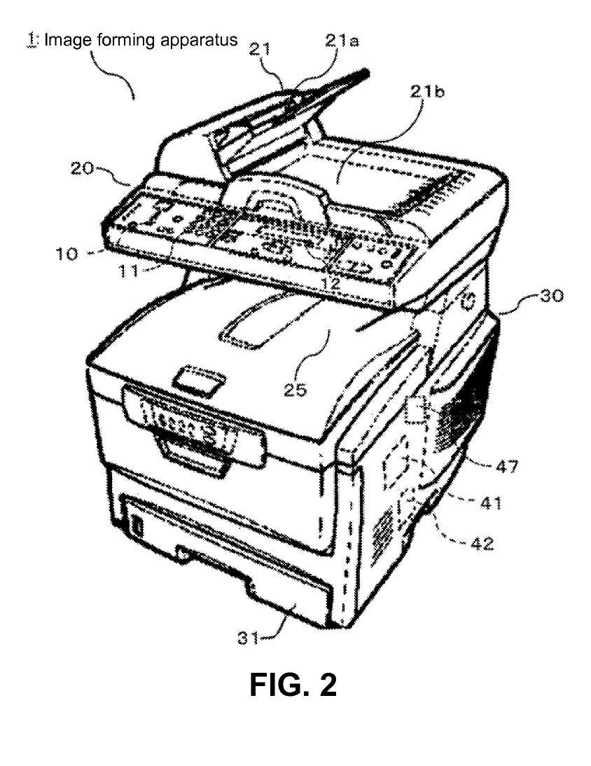

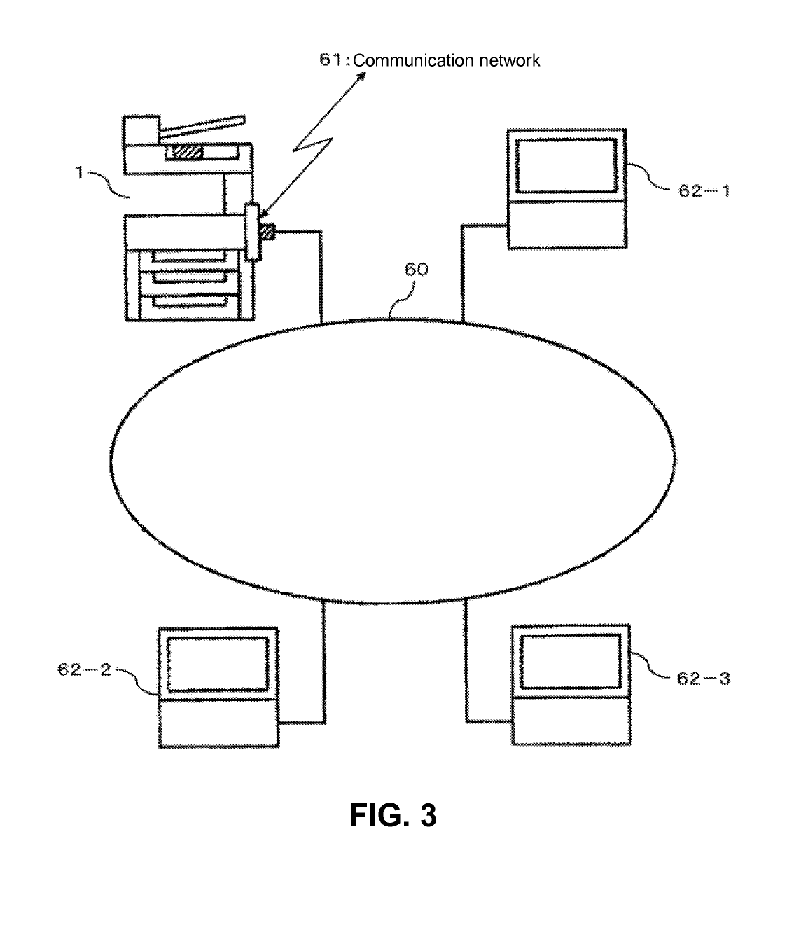

A first embodiment of the present invention will be explained. FIG. 1 is a block diagram showing a configuration of an image forming apparatus 1 according to the first embodiment of the present invention. FIG. 2 is a schematic perspective view showing the image forming apparatus 1 according to the first embodiment of the present invention. FIG. 3 is a schematic view showing an example of a network to which the image forming apparatus 1 is connected according to the first embodiment of the present invention.

As shown in FIG. 2, the image forming apparatus 1 is a multi function product (referred to as an MFP) having functions of a scanner, a copier, a printer, and a facsimile for inputting and transmitting image data.

As shown in FIG. 3, the image forming apparatus 1 is connected to a network 60 such as a local area network (LAN) or internet, so that the image forming apparatus 1 is capable of receiving and transmitting data through the network 60. The image forming apparatus 1 is also connected to a communication network 61 such as a public telephone network, so that the image forming apparatus 1 is capable of receiving and transmitting data through the communication network 61. The network 60 is connected to external devices 62-1, 62-2, and 62-3, so that the image forming apparatus 1 is capable of receiving and transmitting data from and to the external devices 62-1, 62-2, and 62-3.

As shown in FIG. 2, the image forming apparatus 1 includes an operation panel 10 at an upper portion thereof. The operation panel 10 includes an operation unit such as various input keys 11 for receiving various instructions and data such as a text and a number through an operation of an operator. The operation panel 10 also includes a display unit 12 such as an LCD for displaying information regarding an instruction menu for the operator and an acquired image.

In the embodiment, a reading unit 20 such as a scanner unit is disposed near the operation panel 10 for optically reading an original to obtain the image data. An automatic original transportation unit 21 is disposed above the reading unit 20. The automatic original transportation unit 21 includes an original placing portion 21a and a discharge portion 21b.

In the embodiment, a printing unit 30 such as a printer portion is disposed under the reading unit 20 for printing an image on a recording sheet according to the image data. A tray 25 is disposed between the reading unit 20 and the printing unit 30 for discharging the recording sheet after the image is printed on the recording sheet. A sheet supply unit 31 is detachably attached to a lower portion of the printing unit 30 for supplying the recording sheet.

As shown in FIGS. 1 and 2, the operation panel 10 is provided for inputting various inputs including a selection of a transmission destination by the operator, and includes the various input keys 11 or the operation unit. The various input keys 11 include, for example, a start key 11a for instructing a start of an operation; a stop key 11b for instructing a termination of an operation; an address book key 11c for specifying a destination; a job memory key 11d for storing and executing a series of key operations as a job; and the likes.

In the embodiment, through pushing the address book key 11c, it is possible to display an e-mail address registered in a job memory 45 disposed in the image forming apparatus 1, so that a destination is selected, or to input an e-mail shortcut dial number through the operation panel 10, so that an e-mail address associated with the e-mail shortcut dial number is selected and an e-mail is sent to the e-mail address.

In the embodiment, with the operation panel 10, it is possible to perform operations of deleting and adding the e-mail shortcut dial number as follows. First, in an operation of registering and editing the e-mail shortcut dial number, it is possible to newly register the e-mail shortcut dial number or edit the e-mail shortcut dial number already registered. Second, in an operation of deleting and moving forward the e-mail shortcut dial number, it is possible to delete the e-mail shortcut dial number and move forward a subsequent e-mail shortcut dial number. Third, in an operation of inserting the e-mail shortcut dial number, it is possible to inserting a new e-mail shortcut dial number into an arbitrary position and move backward a subsequent e-mail shortcut dial number.

In the embodiment, the input keys 11 and the LCD 12 of the operation panel 10 function as a main portion of a user interface. The display unit 12 is provided for displaying an entire portion of a destination list when a destination of data transmission is specified, and for displaying a setting screen when a scanning condition or a data transmission condition is set.

In the embodiment, the reading unit 20 disposed near the operation panel 10 includes a flat bed 20a for placing the original, and functions as a reading unit or an input unit for optically reading image information such as a picture, a letter, a graphic, and the like from the original to obtain the image data or an image signal.

In the embodiment, the printing unit 30 disposed under the reading unit 20 is retained in a main body of the image forming apparatus 1. In the main body thereof, the image forming apparatus 1 further includes a control unit 40 such as a central processing unit (CPU) for controlling an entire operation of the image forming apparatus 1; a communication unit 41; an electrical file storage unit 42; an image data creation unit 43; a file creation unit 44; the job memory 45 such as a flash memory for storing the job; a program memory 46 such as a non-volatile memory for storing various programs; an information searching unit 47 such as an inside job memory table e-mail information searching unit for determining whether the job is stored in the job storage unit 45; a job memory table deletion unit 48; and the likes. The components described above are mutually connected to the operation panel 10, the reading unit 20, the automatic original transportation unit 21, and the printing unit 30 through an internal bus 15 and the like.

In the embodiment, the communication unit 41 includes a data communication unit 41a and the like, so that the communication unit 41 transmits and receives the image data to and from the external devices 62-1, 62-2, and 62-3 through the network 60 shown in FIG. 3. The image forming apparatus 1 includes a network interface (not shown) for connecting to the network 60, an interface for receiving facsimile data from the communication network 61, and the like. Further, the communication unit 41 is connected to the network 60, so that the communication unit 41 transmits and receives various data to and from the external devices 62-1, 62-2, and 62-3 through the network interface, and is also connected to the communication network 61.

In the embodiment, the electrical file storage unit 42 is provided for storing an electrical file created internally or acquired through transmission and reception, and is formed of a magnetic disk device and the like.

In the embodiment, the job memory 45 includes a job storage unit 45a such as a job memory key table 45a for storing a series of key operations, and a destination information storage unit 45b such as an e-mail shortcut dial number table 45b for storing destination information such as an e-mail address for transmitting to a destination and the e-mail shortcut dial number associated with the destination information.

In the embodiment, the information searching unit 47 or the inside job memory table e-mail information searching unit 47 is provided for searching a keyword such as the e-mail shortcut dial number associated with the e-mail address among key information stored in the job memory key table 45a. The job memory table deletion unit 48 is provided for deleting the job stored or registered in the job memory 45.

An entire function of the image forming apparatus 1 with the configuration described above will be explained next. The image signal created at the reading unit 20 is converted into digital data at the image data creation unit 43. After various image processes are performed on the digital data, the digital data are sent to the printing unit 30 or the communication unit 41, so that an image is printed or the digital data are transmitted. Further, the digital data are stored in the electrical file storage unit 42, so that the digital data can be utilized later.

In the embodiment, the printing unit 30 prints the image on the recording sheet according to the image data acquired with the reading unit 20, the image data received with the communication unit 41 from the external devices 62-1, 62-2, and 62-3, or the image data stored in the electrical file storage unit 42. The communication unit 41 receives and transmits the facsimile data through the communication network 61. Further, the communication unit 41 receives and transmits the data from and to the external devices 62-1, 62-2, and 62-3 using the e-mail and the like.

Accordingly, in the embodiment, the image forming apparatus 1 has the function of a facsimile capable of performing ordinary facsimile communication, and also functions as a terminal capable of receiving and transmitting an e-mail. Accordingly, it is possible to transmit or receive various image data as an attachment to an e-mail. Note that the image forming apparatus 1 is capable of performing the network communication through a wired network or a wireless network.

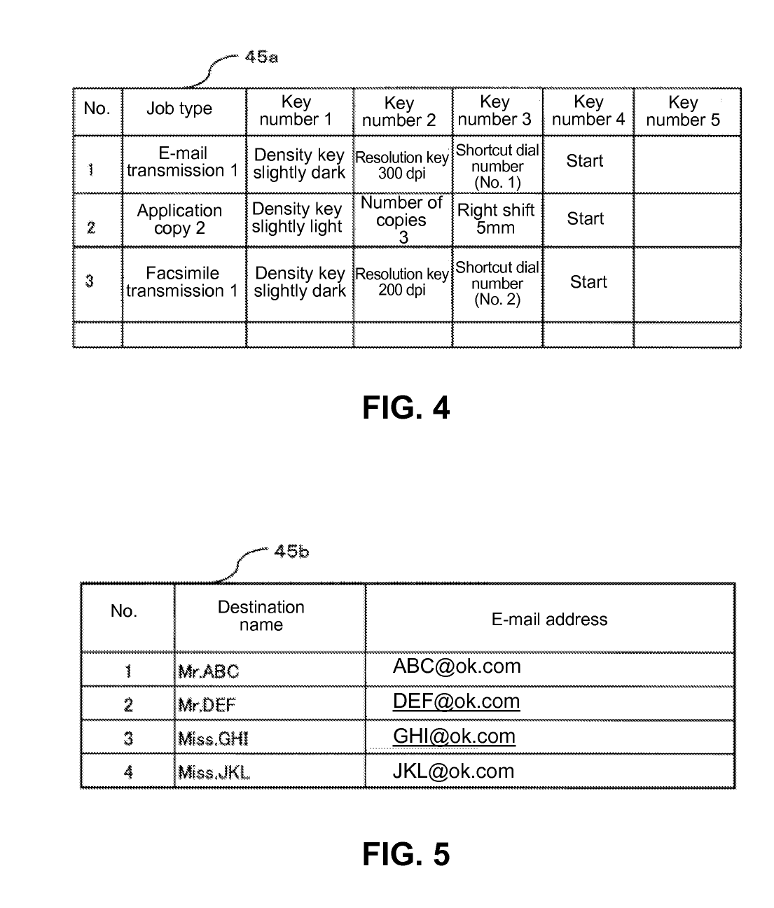

Contents of the job memory key table 45a will be explained next. FIG. 4 is a schematic view showing an example of the contents of the job memory key table 45a of the image forming apparatus 1 according to the first embodiment of the present invention.

As shown in FIG. 4, job memory numbers No. 1, No. 2, and No. 3, corresponding job types, and key numbers 1 to 5 are registered in the job memory key table 45a. For example, in FIG. 4, the job memory number No. 1 is assigned to a job for e-mail transmission 1; the job memory number No. 2 is assigned to a job for application copy 2; and the job memory number No. 3 is assigned to a job for facsimile transmission 1.

Contents of the e-mail shortcut dial number table 45b will be explained next. FIG. 5 is a schematic view showing an example of the contents of the e-mail shortcut dial number table 45b of the image forming apparatus 1 according to the first embodiment of the present invention.

As shown in FIG. 5, destination names and e-mail addresses corresponding to e-mail shortcut dial numbers No. 1 to No. 4 are registered in the e-mail shortcut dial number table 45b.

For example, ABC@ok.com is registered in the e-mail shortcut dial number No. 1 as an e-mail address of Mr. ABC. Similarly, DFE@ok.com is registered in the e-mail shortcut dial number No. 2 as an e-mail address of Mr. DEF; GHI@ok.com is registered in the e-mail shortcut dial number No. 3 as an e-mail address of Mr. GHI; and JKL@ok.com is registered in the e-mail shortcut dial number No. 4 as an e-mail address of Mr. JKL.

An operation of registering the job in the job memory 45, executing the job in the job memory 45, and registering and deleting the e-mail shortcut dial number will be explained next.

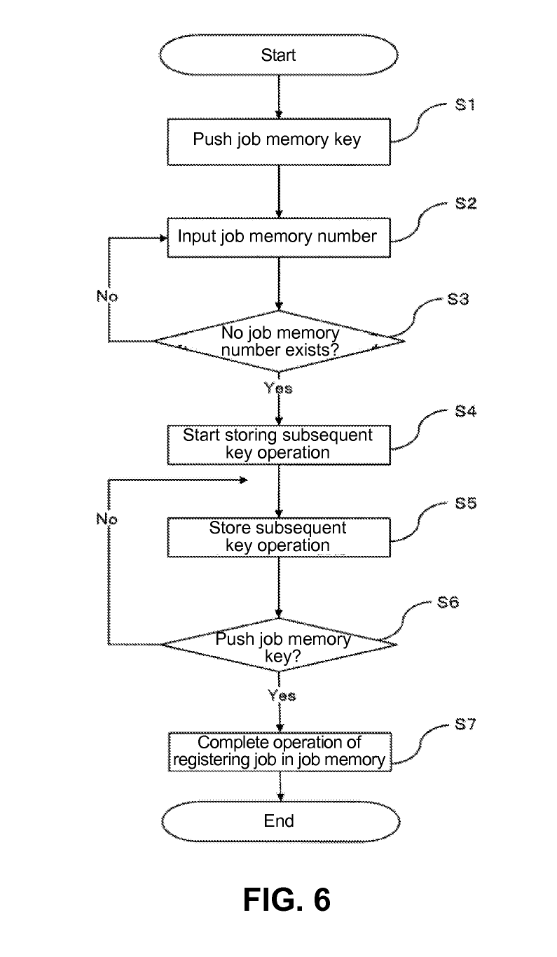

FIG. 6 is a flow chart showing the operation of registering the job in the job memory 45 of the image forming apparatus 1 according to the first embodiment of the present invention.

When the operation of registering the job in the job memory 45 starts, the following steps S1 to S7 are performed according to a program stored in the program memory 46 under the control of the CPU 40.

In step S1, the operator pushes the job memory key 11b of the operation panel 10. In step S2, a screen is displayed on the LCD 12 for prompting an input of the job memory number, so that the operator inputs the job memory number using the input keys 11. In step S3, it is determined whether no job memory number exists in the job memory key table 45a. In steps S4 to S6, when it is determined that no job memory number exists in the job memory key table 45a (Yes), a subsequent key operation is stored in the job memory 45 until the job memory key 11d is pushed one more time.

When it is determined that the job memory number thus input exists in the job memory key table 45a (No) in step S3, the process returns to step S2 in which the job memory number is input.

As an example, in a state that the job memory number No. 1 is not registered, when specific keys of the input keys 11 such as a density key “slightly dark”, a resolution key “300 dpi”, and the e-mail shortcut dial number No. 1 are pushed and the start key 11a is pushed at last, the sequential operation is registered in the job memory number 1 of the job memory key table 45a shown in FIG. 4. Lastly, in step S7, the operation of registering the job in the job memory 45 is complete.

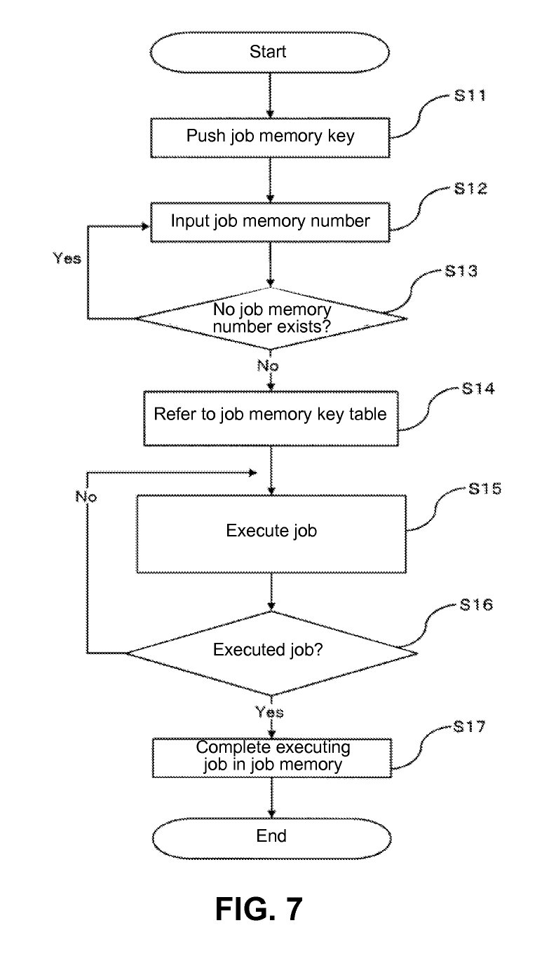

FIG. 7 is a flow chart showing the operation of executing the job in the job memory 45 of the image forming apparatus 1 according to the first embodiment of the present invention. The flow chart shown in FIG. 7 shows the operation of transmitting an e-mail using the job memory No. 1 registered in the job memory key table 45a shown in FIG. 4.

When the operation of executing the job in the job memory 45 starts, the following steps S11 to S17 are performed according to a program stored in the program memory 46 under the control of the CPU 40.

In step S11, the operator pushes the job memory key 11b of the operation panel 10. In step S12, a screen is displayed on the LCD 12 for prompting an input of the job memory number, so that the operator inputs the job memory number using the input keys 11. In step S13, it is determined whether no job memory number exists in the job memory key table 45a. In step S14, when it is determined that the job memory number thus input exists in the job memory key table 45a (No), the job memory key table 45a corresponding to the job memory number thus input is referred. In step S15, the job is executed to assume that the key operation is performed according to the sequential operation in the job memory key table 45a.

When it is determined that no job memory number exists in the job memory key table 45a (Yes) in step S13, the process returns to step S12 in which the job memory number is input.

As an example, when the original is placed on the reading unit 20 and the job memory number No. 1 is selected, the job is performed to assume that the specific keys of the input keys 11 such as the density key “slightly dark”, a resolution key “300 dpi”, and the e-mail shortcut dial number No. 1 are pushed according to the job memory key table 45a shown in FIG. 4. Lastly, in steps S16 and 17, after the data is transmitted as the attachment of the e-mail to the e-mail shortcut dial number No. 1, so that the operation of executing the job in the job memory 45 is complete.

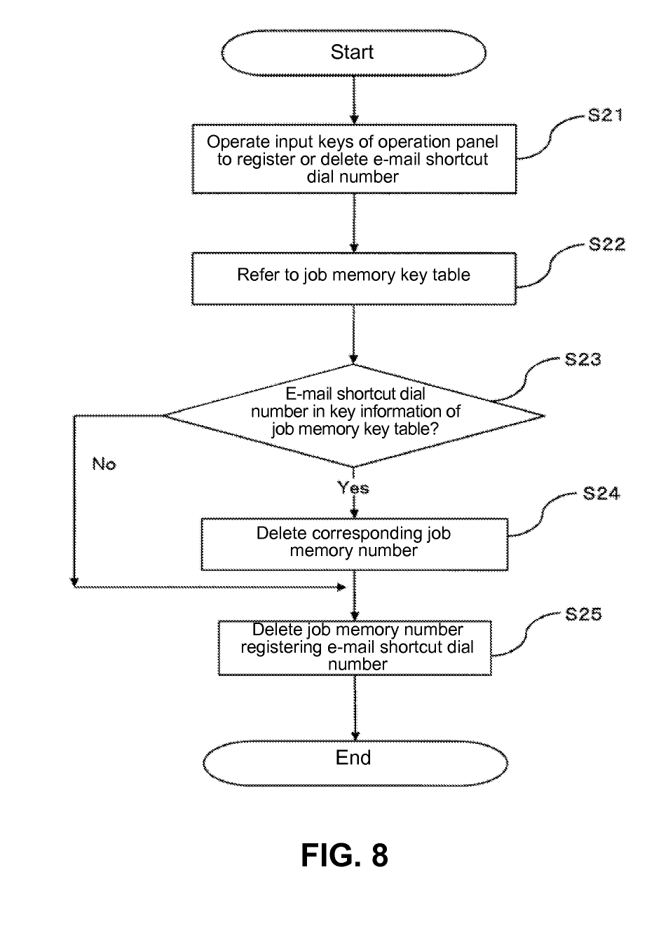

FIG. 8 is a flow chart showing the operation of registering and deleting the e-mail shortcut dial number in the job memory 45 of the image forming apparatus 1 according to the first embodiment of the present invention. The flow chart shown in FIG. 8 shows the operation of deleting the e-mail shortcut dial number No. 1 registered in the e-mail shortcut dial number table 45b shown in FIG. 5, and deleting the job memory No. 1 registered in the job memory key table 45a shown in FIG. 4.

When the operation of registering and deleting the e-mail shortcut dial number in the job memory 45 starts, the following steps S21 to S25 are performed according to a program stored in the program memory 46 under the control of the CPU 40.

In step S21, the operator operates the input keys 11 of the operation panel 10 to register or delete the e-mail shortcut dial number. In step S22, the CPU 40 refers to the job memory key table 45a with the information searching unit 47. In step S23, it is determined whether information of the e-mail shortcut dial number exists in key information of the job memory key table 45a. In step S24, when it is determined that the information of the e-mail shortcut dial number exists in the key information of the job memory key table 45a, the corresponding job memory number is deleted.

In the example shown in FIG. 4, the job memory number No. 1 is assigned to the job for the e-mail transmission 1; the job memory number No. 2 is assigned to the job for the application copy 2; and the job memory number No. 3 is assigned to the job for the facsimile transmission 1. When the e-mail shortcut dial number No. 1 is deleted, the information searching unit 47 detects the information of the e-mail shortcut dial number No. 1 of the job memory key table 45a. Accordingly, the job memory number No. 1 is deleted from the job memory key table 45a.

In the embodiment, when the e-mail shortcut dial number No. 1 is updated or an e-mail address is added, it is possible to delete the job memory number registering the e-mail shortcut dial number in step S25. Accordingly, it is possible to prevent the e-mail from being transmitted to a wrong e-mail address when the e-mail is transmitted using the job.

As described above, in the embodiment, the job memory key table 45a registers the e-mail transmission job containing the e-mail shortcut dial number information in which the e-mail address is registered. When the e-mail shortcut dial number is added or deleted, or the e-mail address is updated, and the information of the e-mail shortcut dial number is detected in the job memory key table 45a, the job is deleted. Accordingly, it is possible to prevent an e-mail from being transmitted to a wrong e-mail address, thereby improving security.

In the embodiment, the e-mail address is explained as the destination information of the job, and the present invention is not limited thereto. The destination information of the job may be a telephone number or a facsimile number.

### Second Embodiment

A second embodiment of the present invention will be explained next. In the second embodiment, the image forming apparatus 1 has a configuration the same as that in the first embodiment shown in FIGS. 1 and 2. Further, the operation of registering the job in the job memory 45 in the second embodiment is the same as that in the first embodiment shown in FIG. 6, and the operation of executing the job in the job memory 45 in the second embodiment is the same as that in the first embodiment shown in FIG. 7.

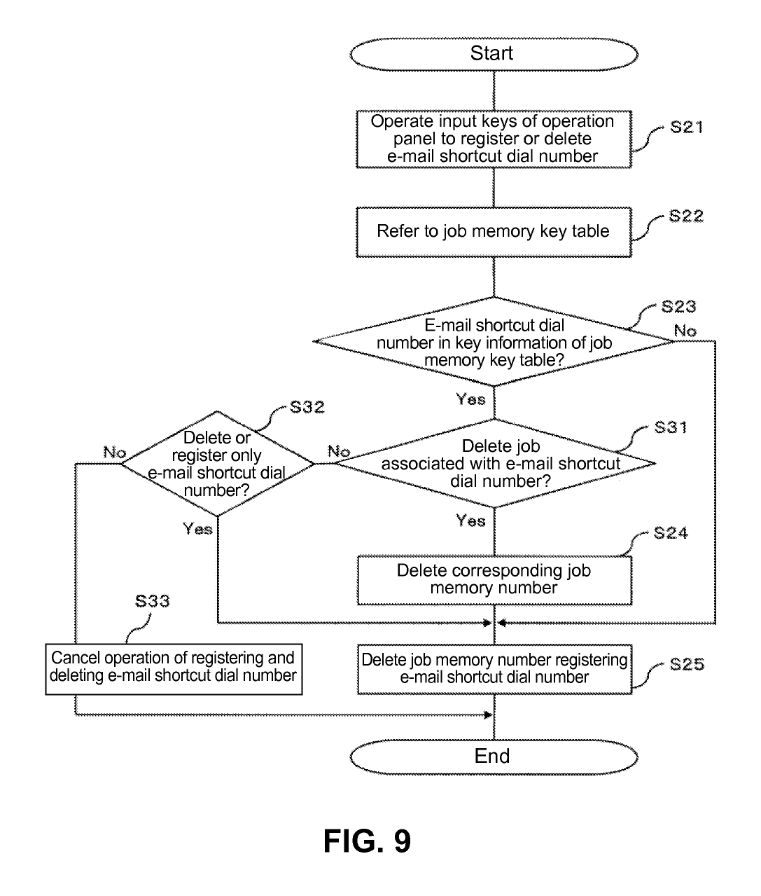

An operation of registering and deleting the e-mail shortcut dial number in the job memory 45 will be explained. FIG. 9 is a flow chart showing the operation of registering and deleting the e-mail shortcut dial number in the job memory 45 of the image forming apparatus 1 according to the second embodiment of the present invention.

In FIG. 9, steps similar to those shown in FIG. 8 are designated with the same reference numerals. The flow chart shown in FIG. 9 shows the operation of deleting the e-mail shortcut dial number No. 1 registered in the e-mail shortcut dial number table 45b shown in FIG. 5, and deleting the job memory No. 1 registered in the job memory key table 45a shown in FIG. 4.

In the operation of registering and deleting the e-mail shortcut dial number in the second embodiment, step S31 is inserted between step S23 and step S24 in the first embodiment. Further, step S32 and step S33 are inserted between step S31 and steps S24 and S25.

When the operation of registering and deleting the e-mail shortcut dial number in the job memory 45 starts, the process similar to steps S21 to S25 in the first embodiment is performed.

In step S23, the e-mail shortcut dial number to be registered or deleted is searched in the key information of the job memory key table 45a, so that it is determined whether information of the e-mail shortcut dial number exists in key information of the job memory key table 45a. When it is determined that the e-mail shortcut dial number does not exist in the key information of the job memory key table 45a (No in step S23), the process proceeds to step S25. When it is determined that the e-mail shortcut dial number exists in the key information of the job memory key table 45a (Yes in step S23), the process proceeds to step S31.

In step S31, when it is determined that the e-mail shortcut dial number exists in the key information of the job memory key table 45a in step S23, the CPU 40 displays the job memory number of the job associated with the e-mail shortcut dial number to be registered or deleted on the LCD 12. Further, the CPU 40 displays a screen on the LCD 12 for prompting the operator to select whether the job associated with the e-mail shortcut dial number is deleted through the operation of the input keys 11 of the operation panel 10.

When the operator does not select that the job associated with the e-mail shortcut dial number is deleted (No in step S31), the process proceeds to step S32. When the operator selects that the job associated with the e-mail shortcut dial number is deleted (Yes in step S31), the process proceeds to step S24.

In step S24, when the operator selects that the job associated with the e-mail shortcut dial number is deleted in step S31, the corresponding job is deleted, and the process proceeds to step S25.

In step S32, when the operator does not select that the job associated with the e-mail shortcut dial number is deleted (No in step S31), the CPU 40 displays a screen on the LCD 12 for prompting the operator to select whether only the e-mail shortcut dial number is registered or deleted through the operation of the input keys 11 of the operation panel 10 without registering or deleting the job associated with the e-mail shortcut dial number.

When the operator selects that the e-mail shortcut dial number is registered or deleted (Yes in step S32), the process proceeds to step S25. When the operator does not select that the e-mail shortcut dial number is registered or deleted (No in step S32), the process proceeds to step S33.

In step S33, when the operator does not select that the e-mail shortcut dial number is registered or deleted in step S32, the CPU 40 cancels the operation of registering and deleting the e-mail shortcut dial number. Accordingly, when the e-mail shortcut dial number is registered or deleted, it is possible for the operator to select whether registering or deleting the job associated with the e-mail shortcut dial number when the e-mail shortcut dial number is registered or deleted.

For example, when an e-mail address of a destination is registered and associated in the job memory 45, and the e-mail address is updated for some reason, it is possible for the operator to update the e-mail address without deleting the association with the job memory 45.

In the embodiment, the e-mail address is explained as the destination information of the job, and the present invention is not limited thereto. The destination information of the job may be a telephone number or a facsimile number.

### Third Embodiment

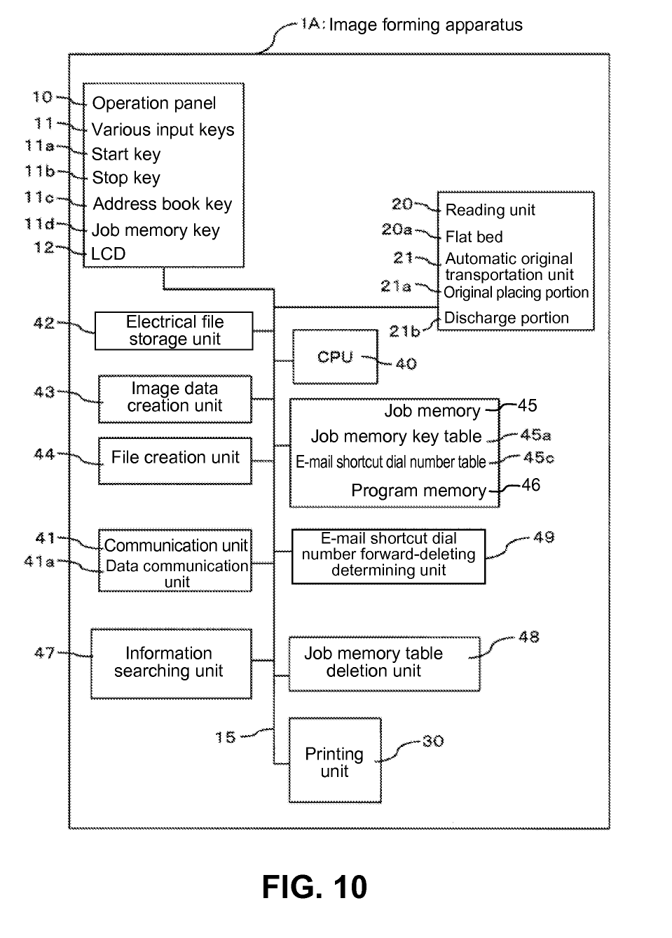

A third embodiment of the present invention will be explained next. FIG. 10 is a block diagram showing a configuration of an image forming apparatus 1A according to the third embodiment of the present invention. Components in the third embodiment similar to those in the first embodiment shown in FIG. 1 are designated with the same reference numerals.

In the third embodiment, the image forming apparatus 1A includes an e-mail shortcut dial number table 45c instead of the e-mail shortcut dial number table 45b of the image forming apparatus 1 in the first embodiment. Further, the image forming apparatus 1A includes a determining unit such as an e-mail shortcut dial number forward-deleting determining unit 49.

In the embodiment, the e-mail shortcut dial number table 45c includes an identifying unit such as a job memory identification area in addition to the contents of the e-mail shortcut dial number table 45b. The job memory identification area is provided for determining whether the e-mail shortcut dial number is used as the job.

In the embodiment, the e-mail shortcut dial number forward-deleting determining unit 49 determines whether a forward-deleting operation is possible according to the job memory identification area. In the forward-deleting operation, the e-mail shortcut dial number already registered is deleted and a subsequent e-mail shortcut dial number is moved forward.

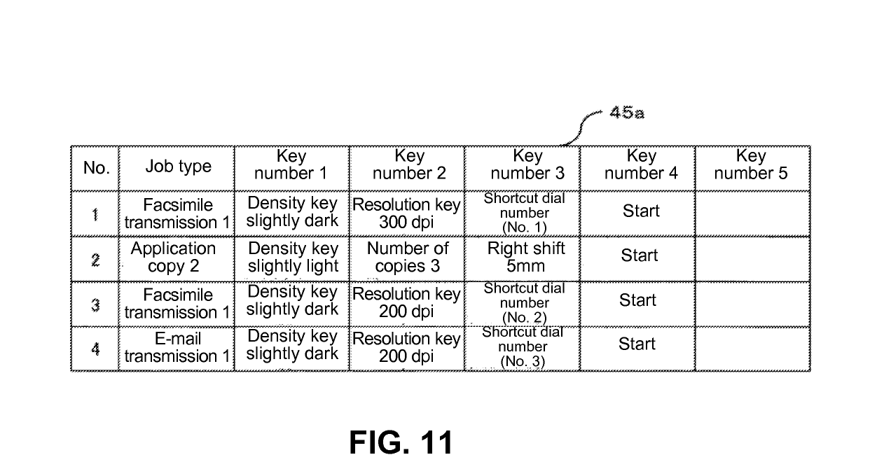

Contents of the job memory key table 45a will be explained next. FIG. 11 is a schematic view showing an example of the contents of the job memory key table 45a of the image forming apparatus 1A according to the third embodiment of the present invention. FIG. 11 corresponds to FIG. 4 in the first embodiment.

As shown in FIG. 11, similar to the first embodiment, the job memory numbers No. 1, No. 2, No. 3, and No. 4 corresponding job types, and key numbers 1 to 5 are registered in the job memory key table 45a. For example, in FIG. 11, the job memory number No. 1 is assigned to the job for the e-mail transmission 1; the job memory number No. 2 is assigned to the job for the application copy 2; the job memory number No. 3 is assigned to the job for the facsimile transmission 1; and the job memory number No. 4 is assigned to the job for the e-mail transmission 1.

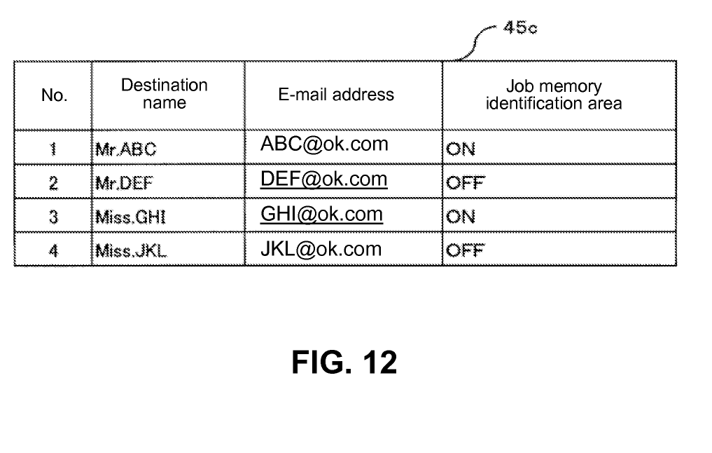

Contents of the e-mail shortcut dial number table 45c will be explained next. FIG. 12 is a schematic view showing an example of contents of the e-mail shortcut dial number table 45c of the image forming apparatus 1A according to the third embodiment of the present invention. FIG. 12 corresponds to FIG. 5 in the first embodiment. As shown in FIG. 12, the job memory identification area is added in the e-mail shortcut dial number table 45c.

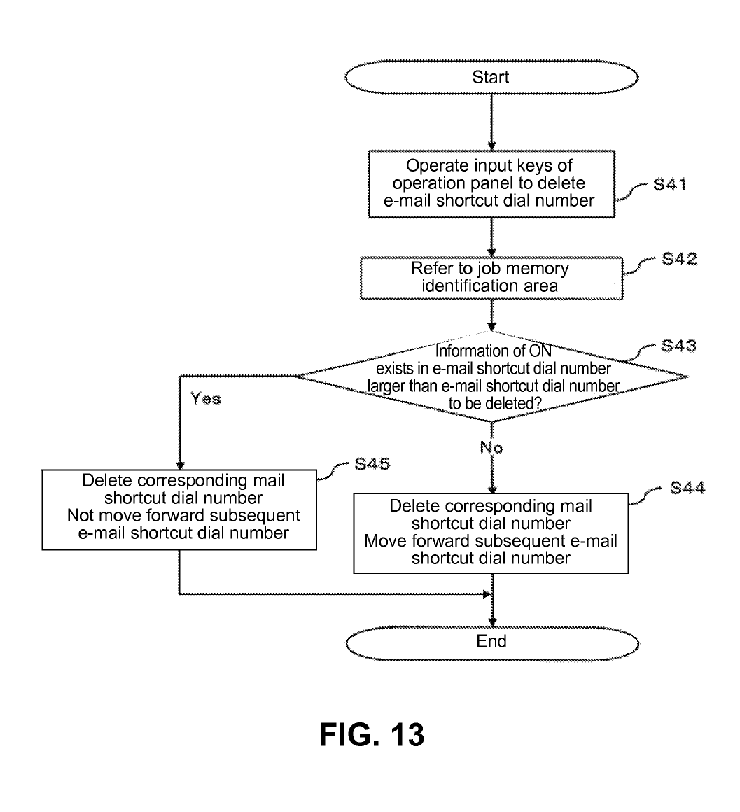

An operation of forward-deleting the e-mail shortcut dial number in the job memory 45 will be explained next. FIG. 13 is a flow chart showing the operation of forward-deleting the e-mail shortcut dial number in the job memory 45 of the image forming apparatus 1A according to the third embodiment of the present invention. The flow chart shown in FIG. 13 shows the operation of forward-deleting the e-mail shortcut dial number from the e-mail shortcut dial number table 45c.

When the operation of forward-deleting the e-mail shortcut dial number from the e-mail shortcut dial number table 45c starts, the following steps S41 to S45 are performed.

In step S41, the operator operates the input keys 11 of the operation panel 10 to delete the e-mail shortcut dial number. In step S42, the CPU 40 refers to the job memory identification area in the e-mail shortcut dial number table 45c. In step S43, it is determined whether information of ON (associated with the job) exists in an e-mail shortcut dial number larger than the e-mail shortcut dial number to be deleted.

In step S45, when it is determined the information of ON (associated with the job) exists in the e-mail shortcut dial number larger than the e-mail shortcut dial number to be deleted (Yes in step S43), the corresponding mail shortcut dial number is deleted, and a subsequent e-mail shortcut dial number is not moved forward.

In step S44, when the CPU 40 refers to the job memory identification area in the e-mail shortcut dial number table 45c, and it is determined the information of ON (associated with the job) does not exist in the e-mail shortcut dial number larger than the e-mail shortcut dial number to be deleted (Yes in step S43), the corresponding mail shortcut dial number is deleted, and the subsequent e-mail shortcut dial number is moved forward.

For example, in the job memory key table 45a shown in FIG. 11, the job memory number No. 1 is assigned to the job for the e-mail transmission 1, and the e-mail shortcut dial number No. 1 is used. The job memory number No. 2 is assigned to the job for the application copy 2; and the job memory number No. 3 is assigned to the job for the facsimile transmission 1, and the e-mail shortcut dial number is not used in both of them. The job memory number No. 4 is assigned to the job for the e-mail transmission 1, and the e-mail shortcut dial number No. 3 is used.

For example, in the e-mail shortcut dial number table 45c shown in FIG. 12, the e-mail shortcut dial number No. 1 is used in the job memory number No. 1, and the e-mail shortcut dial number No. 3 is used in the job memory number No. 4. Accordingly, the e-mail shortcut dial numbers No. 1 and No. 3 have the information of ON in the job memory identification area in the e-mail shortcut dial number table 45c. On the other hand, the e-mail shortcut dial numbers No. 2 and No. 4 are not used in the job memory numbers No. 1 to No. 4. Accordingly, the e-mail shortcut dial numbers No. 2 and No. 4 do not have the information of ON in the job memory identification area in the e-mail shortcut dial number table 45c.

In the example described above, when the e-mail shortcut dial number No. 2 is deleted in the forward-deleting operation, in step S43, it is determined that the information of ON (associated with the job) exists in the e-mail shortcut dial number No. 3 larger than the e-mail shortcut dial number No. 2 to be deleted. Accordingly, the corresponding mail shortcut dial number No. 2 is deleted, and the subsequent e-mail shortcut dial number No. 3 is not moved forward.

On the other hand, when the e-mail shortcut dial number No. 3 is deleted in the forward-deleting operation, in step S43, it is determined that the information of ON (associated with the job) does not exist in the e-mail shortcut dial number No. 4 larger than the e-mail shortcut dial number No. 3 to be deleted. Accordingly, the corresponding mail shortcut dial number No. 3 is deleted, and the subsequent e-mail shortcut dial number No. 4 is moved forward. Accordingly, it is possible to use the job memory number even when the e-mail shortcut dial numbers No. 2 and No. 3 are deleted, thereby improving operability.

As described above, in the third embodiment, the job memory key table 45a registers the e-mail transmission job containing the e-mail shortcut dial number information in which the e-mail address is registered. Further, the e-mail shortcut dial number table 45c includes the job memory identification area for determining whether the e-mail shortcut dial number is used as the job. Further, the e-mail shortcut dial number forward-deleting determining unit 49 determines whether the forward-deleting operation, in which the e-mail shortcut dial number already registered is deleted and the subsequent e-mail shortcut dial number is moved forward, is possible according to the job memory identification area.

Accordingly, when the e-mail shortcut dial number is deleted in the forward-deleting operation it is possible to use the job memory numbers as before, thereby improving operability.

In the embodiment, the e-mail address is explained as the destination information of the job, and the present invention is not limited thereto. The destination information of the job may be a telephone number or a facsimile number.

The present invention is not limited to the embodiments described above, and may be modified. For example, the outer appearance and the functional units of the image forming apparatus 1 or the image forming apparatus 1A may be modified to a configuration and a function other than those shown in the drawings. Further, the present invention may be applicable to an image reading apparatus such as a copier, a facsimile, and the like capable of storing an original as an electrical file.

The disclosure of Japanese Patent Application No. 2009-126263, filed on May 26, 2009, is incorporated in the application.

While the invention has been explained with reference to the specific embodiments of the invention, the explanation is illustrative and the invention is limited only by the appended claims.

What is claimed is:

1. An image forming apparatus comprising:
an operation unit for inputting an operation;
a job storage unit for storing a job correlating the operation to a sequential operation;
a control unit for performing the job;
a destination storage unit for storing destination information; and
an information searching unit for determining whether the job including an operation of transmission to the destination information is stored in the job storage unit, wherein said control unit is arranged to perform a specific operation when the information searching unit determines that the job including the operation of transmission to the destination information is stored in the job storage unit after the destination information is changed.

2. The image forming apparatus according to claim 1, where said control unit is arranged to perform the specific operation of deleting the job from the job storage unit.

3. The image forming apparatus according to claim 1, where said control unit is arranged to perform the specific operation of determining whether the job is deleted from the job storage unit.

4. The image forming apparatus according to claim 1, where said control unit is arranged to perform the specific operation after the destination information is deleted or registered.

5. The image forming apparatus according to claim 1, further comprising an identifying unit disposed in the destination storage unit for identifying whether the job is registered, and a determining unit for deleting the job and determining whether another job is moved forward.

6. The image forming apparatus according to claim 1, wherein said destination storage unit is arranged to store destination information including an electric mail address.
